(19) United States
(12) Patent Application Publication
(10) Pub. No.: US 2026/0141679 A1
(43) Pub. Date: May 21, 2026

(54) METHOD OF OBJECT CLUSTER REGISTRATION OF DISSIMILAR ROOMS USING GEOMETRIC SPATIAL AFFORDANCE GRAPH, METHOD OF GENERATING SHARED VIRTUAL SPACES INCLUDING THE SAME, ELECTRONIC SYSTEM FOR PERFORMING THE SAME AND COMPUTER READABLE MEDIUM HAVING PROGRAM FOR PERFORMING THE SAME

(71) Applicant: Korea Advanced Institute of Science and Technology, Daejeon (KR)

(72) Inventors: Woontack WOO, Daejeon (KR); Seonji KIM, Daejeon (KR); Dooyoung KIM, Daejeon (KR); Jae-eun SHIN, Daejeon (KR)

(73) Assignee: Korea Advanced Institute of Science and Technology, Daejeon (KR)

(21) Appl. No.: 19/392,493

(22) Filed: Nov. 18, 2025

(30) Foreign Application Priority Data
Nov. 19, 2024 (KR) 10-2024-0165710
Nov. 12, 2025 (KR) 10-2025-0170180

(51) Int. Cl. G06V 10/762; G06T 19/00

(52) U.S. Cl. CPC G06V 10/7635; G06T 19/006

(57) ABSTRACT

A method of an object cluster registration of dissimilar rooms using a geometric spatial affordance graph, the method includes generating a host geometric spatial affordance graph of a host space, generating a client geometric spatial affordance graph of a client space, generating a host object cluster by operating an object clustering for the host geometric spatial affordance graph, generating a client object cluster by operating the object clustering for the client geometric spatial affordance graph and operating the object cluster registration between the host object cluster and the client object cluster.

### CROSS REFERENCE TO RELATED APPLICATIONS

This application claims priority under 35 U.S.C. § 119 to Korean Patent Application No. 10-2024-0165710, filed on Nov. 19, 2024 and Korean Patent Application No. 10-2025-0170180, filed on Nov. 12, 2025 in the Korean Intellectual Property Office (KIPO), the contents of which are herein incorporated by reference in their entireties.

### BACKGROUND

### 1. Technical Field

Embodiments relate to a method of an object cluster registration of dissimilar rooms, a method of generating shared virtual spaces including the same, an electronic system for performing the same and a non-transitory computer-readable storage medium having stored thereon program instructions of the method. More particularly, embodiments relate to a method of an object cluster registration of dissimilar rooms using a geometric spatial affordance graph, a method of generating shared virtual spaces including the same, an electronic system for performing the same and a non-transitory computer-readable storage medium having stored thereon program instructions of the method.

### 2. Description of the Related Art

With various video conferencing platforms such as Zoom, Microsoft Teams, and Google Meet, users may collaborate while engaging in face-to-face interaction despite being physically distant from one another. However, there is an increasing demand for communication beyond the confines of a 2D screen that closely resembles meeting and working together in person. For this, advancements in Augmented Reality (AR), Virtual Reality (VR), and Mixed Reality (MR) technology have enabled remote collaboration in shared virtual spaces based on the real environment, such as meeting rooms, workspaces, and studios, which involves a wide range of 3D interactions. Such collaboration scenarios call for the need to consider, incorporate, and align the physical environment of each user located remotely in different spaces to support these interactions. This has led to research focusing on the spatial aspects of MR remote collaboration for more realistic and immersive experiences.

Efforts to replicate real-world interactions in shared virtual spaces have explored resolving spatial discrepancies by adjusting avatar positions or aligning common spatial features, often overlooking the unique configurations of individual spaces. Previous studies focusing on this aspect emphasized one-to-one semantic object similarity across user spaces, neglecting intra-space object relationships. Moreover, quantitative measures for object relationships, critical for addressing spatial disparities in shared virtual space generation, have been underexplored. In addition, methods to generate shared virtual spaces from multiple dissimilar spaces have primarily focused on maximizing the area of the outcome. This has limited the range of interactions that the shared virtual space can afford to users collaborating in it.

### SUMMARY

Embodiments provide a method of an object cluster registration of dissimilar rooms using a geometric spatial affordance graph capable of extracting optimal object cluster pairs using a relational similarity and a geometric dissimilarity.

Embodiments provide a method of generating shared virtual spaces including the method of the object cluster registration of the dissimilar rooms using the geometric spatial affordance graph.

Embodiments provide an electronic system for performing the method of the object cluster registration of the dissimilar rooms using the geometric spatial affordance graph.

Embodiments provide a non-transitory computer-readable storage medium having stored thereon program instructions of the method of the object cluster registration of the dissimilar rooms using the geometric spatial affordance graph.

In an example method of an object cluster registration of dissimilar rooms using a geometric spatial affordance graph according to the present inventive concept, the method includes generating a host geometric spatial affordance graph of a host space, generating a client geometric spatial affordance graph of a client space, generating a host object cluster by operating an object clustering for the host geometric spatial affordance graph, generating a client object cluster by operating the object clustering for the client geometric spatial affordance graph and operating the object cluster registration between the host object cluster and the client object cluster.

In an embodiment, at least one of the generating the host geometric spatial affordance graph and the generating the client geometric spatial affordance graph may include generating a plurality of nodes in the host geometric spatial affordance graph or in the client geometric spatial affordance graph and generating a plurality of edges connecting the nodes in the host geometric spatial affordance graph or in the client geometric spatial affordance graph.

In an embodiment, the node may include a sittable node, a placeable node and a displayable node.

In an embodiment, the sittable node may include a leanable-sittable node and a not-leanable-sittable node.

In an embodiment, the leanable-sittable node may include an action surface, a constraint surface, an action vector perpendicular to the action surface, a constraint vector perpendicular to the constraint surface and a facing vector.

In an embodiment, when the action vector of the leanable-sittable node is V_{A}, the constraint vector of the leanable-sittable node is V_{C} and the facing vector of the leanable-sittable node is V_{F}, V_{A}⊥V_{F} and V_{C}//V_{F} may be satisfied.

In an embodiment, the not-leanable-sittable node may include an action surface, an action vector perpendicular to the action surface and a facing vector.

In an embodiment, when the action vector of the not-leanable-sittable node is V_{A} and the facing vector of the not-leanable-sittable node is V_{F}, V_{A}⊥V_{F} may be satisfied.

In an embodiment, the placeable node may include an action surface, an action vector perpendicular to the action surface and a facing vector.

In an embodiment, when the action vector of the placeable node is V_{A} and the facing vector of the placeable node is V_{F}, V_{A}⊥V_{F} may be satisfied.

In an embodiment, the displayable node may include an action surface, an action vector perpendicular to the action surface and a facing vector.

In an embodiment, the action vector of the displayable node is V_{A} and the facing vector of the displayable node is V_{F}, V_{A}//V_{F} may be satisfied.

In an embodiment, when an edge type is one of sittable-sittable and displayable-displayable and an angle between a first facing vector of a first node and a second facing vector of a second node is less than θ_{adjacent}, the edge may not be generated between the first node and the second node.

In an embodiment, when an edge type is one of sittable-placeable, displayable-sittable and displayable-placeable and an angle between a first facing vector of a first node and a second facing vector of a second node is less than θ_{basic}, the edge may not be generated between the first node and the second node.

In an embodiment, when an edge type is one of placeable-placeable and displayable-displayable and a distance between a first node and a second node is greater than D_{adjacent}, the edge may not be generated between the first node and the second node.

In an embodiment, an edge weight of the edge may have a value between zero and one. As an interaction between nodes connected to the edge increases, the edge weight may increase.

In an embodiment, when the edge weight is w_{edge}, i is a start node, j is an end node, Â(i,j) is a facing vector angle between a facing vector of the start node and a facing vector of the end node, \hat{D}(i,j) is a Manhattan distance between the start node and the end node, ω_{A} is an angle coefficient and ω_{D} is a distance coefficient, w_{edge}(i,j)=ω_{A}Â(i,j)+ω_{D}\hat{D}(i,j) may be satisfied.

In an embodiment, the host object cluster and the client object cluster may be registered such that a relational similarity between the host object cluster and the client object cluster increases and a geometric dissimilarity between the host object cluster and the client object cluster decreases.

In an embodiment, the relational similarity may be determined by a ratio of a total sum of edge weights in the host object cluster matched with the client object cluster and a total sum of edge weights in the client object cluster matched with the host object cluster to a total sum of edge weights in the host geometric spatial affordance graph and a total sum of edge weights in the client geometric spatial affordance graph.

In an embodiment, the geometric dissimilarity may be determined based on a cumulative difference between individual edge weights in the host geometric spatial affordance graph and individual edge weights in the client geometric spatial affordance graph.

In an embodiment, when G_{H} is the host geometric spatial affordance graph, G_{C} is the client geometric spatial affordance graph, O(G_{H},G_{C}) is an objective function of the object cluster registration, ψᵣₑₗₐₜᵢₒₙ(G_{H},G_{C}) is the relational similarity, ψᵣₑₗₐₜᵢₒₙ(G_{H},G_{C}) is the geometric dissimilarity, ωᵣ is a relational similarity coefficient and ω_{g} is a geometric dissimilarity coefficient, O(G_{H},G_{C})=ωᵣψᵣₑₗₐₜᵢₒₙ(G_{H},G_{C})−ω_{g}ψᵣₑₗₐₜᵢₒₙ(G_{H},G_{C}) may be satisfied.

In an embodiment, when an edge weight of the edge is w_{edge}, i is a start node, j is an end node, Â(i,j) is a facing vector angle between a facing vector of the start node and a facing vector of the end node, \hat{D}(i,j) is a Manhattan distance between the start node and the end node, ω_{A} is an angle coefficient and ω_{D} is a distance coefficient, w_{edge}(i,j)=ω_{A}Â(i,j)+ω_{D}\hat{D}(i,j) may be satisfied. When G is the geometric spatial affordance graph, n(G) is a number of the nodes in the geometric spatial affordance graph and W(G) is a graph weight of the geometric spatial affordance graph,

$$W ( G ) = {\sum }_{i , j = 1}^{n ( G )} {w}_{edge} ( i , j )$$

may be satisfied. When g_{H} is a matched cluster in the host geometric spatial affordance graph and g_{C} is a matched cluster in the client geometric spatial affordance graph,

$${ψ}_{relation} ( {G}_{H} , {G}_{C} ) = \frac{W ( {g}_{H} ) + W ( {g}_{C} )}{W ( {G}_{H} ) + W ( {G}_{C} )}$$

may be satisfied.

In an embodiment, when an edge weight of the edge is w_{edge}, i is a start node, j is an end node, Â(i,j) is a facing vector angle between a facing vector of the start node and a facing vector of the end node, \hat{D}(i,j) is a Manhattan distance between the start node and the end node, ω_{A} is an angle coefficient and ω_{D} is a distance coefficient, w_{edge}=ω_{A}Â(i,j)+ω_{D}\hat{D}(i,j) may be satisfied. When iₕ is a start node in the host geometric spatial affordance graph, jₕ is an end node in the host geometric spatial affordance graph, i_{c} is a start node in the client geometric spatial affordance graph, j_{c} is an end node in the client geometric spatial affordance graph and N is a number of nodes in the matched cluster in the host geometric spatial affordance graph,

$${ψ}_{geometric} ( {G}_{H} , {G}_{C} ) = {\sum }_{{i}_{h} , {j}_{h} , {i}_{c} , {j}_{c} = 1}^{N} ( {w}_{edge} ( {i}_{h} , {j}_{h} ) - {w}_{edge} ( {i}_{c} , {j}_{c} ) )$$

may be satisfied.

In an example method of generating shared virtual spaces according to the present inventive concept, the method includes generating a host geometric spatial affordance graph of a host space, generating a client geometric spatial affordance graph of a client space, generating a host object cluster by operating an object clustering for the host geometric spatial affordance graph, generating a client object cluster by operating the object clustering for the client geometric spatial affordance graph, operating an object cluster registration between the host object cluster and the client object cluster and generating the shared virtual space based on the host object cluster and the client object cluster.

In an embodiment, the shared virtual space may be generated so that an overlapping space of the host space and the client space is maximized while maintaining a registration state of the host object cluster and the client object cluster.

In an embodiment, at least one of the generating the host geometric spatial affordance graph and the generating the client geometric spatial affordance graph may include generating a plurality of nodes in the host geometric spatial affordance graph or in the client geometric spatial affordance graph and generating a plurality of edges connecting the nodes in the host geometric spatial affordance graph or in the client geometric spatial affordance graph.

In an embodiment, the host object cluster and the client object cluster may be registered such that a relational similarity between the host object cluster and the client object cluster increases and a geometric dissimilarity between the host object cluster and the client object cluster decreases.

In an example electronic system according to the present inventive concept, the electronic system is configured to generate a host geometric spatial affordance graph of a host space, generate a client geometric spatial affordance graph of a client space, generate a host object cluster by operating an object clustering for the host geometric spatial affordance graph and generate a client object cluster by operating the object clustering for the client geometric spatial affordance graph.

In an embodiment, the electronic system may include an augmented reality (AR) device worn by a first user disposed in the host space and a virtual reality (VR) device worn by a second user located in the client space. The AR device may be configured to display a shared virtual space generated based on the matched host object cluster and the client object cluster. The VR device may be configured to display the shared virtual space generated based on the matched host object cluster and the client object cluster.

In an example non-transitory computer-readable storage medium having stored thereon program instructions, the program instructions is executable by at least one hardware processor to generate a host geometric spatial affordance graph of a host space, generate a client geometric spatial affordance graph of a client space, generate a host object cluster by operating an object clustering for the host geometric spatial affordance graph, generate a client object cluster by operating the object clustering for the client geometric spatial affordance graph and operate an object cluster registration between the host object cluster and the client object cluster.

According to the method of the object cluster registration of the dissimilar rooms, the method of generating the shared virtual spaces including the same, the electronic system for performing the same and the non-transitory computer-readable storage medium having stored thereon program instructions of the method, a new data structure called a geometric spatial affordance graph (GSAG) based on the facing formation between objects is proposed. The geometric spatial affordance graph (GSAG) may reflect both geometric attributes and semantic attributes. An object cluster registration (OCR) method using the geometric spatial affordance graph (GSAG) is proposed. In the object cluster registration (OCR) method, interactable object clusters may be identified and registered based on affordances. By connecting object clusters through the object cluster registration (OCR), the generated shared virtual space may allow for a wider range of interactions. A technical advantage of the geometric spatial affordance graph (GSAG) is that it does not view objects as individual entities by considering the facing direction and distance of the furniture and determining relationships through these. A technical advantage of the object cluster registration (OCR) lies in the ability to ensure a wider range and greater number of shared objects that may be used together in a shared virtual space.

A capacity of the object cluster registration (OCR) may be demonstrated by comparing registered edge-IoU (REI) and registered area-IoU (RAI) of the shared virtual spaces generated by the object cluster registration (OCR) with conventional methods that do not apply the object cluster registration (OCR) using the geometric spatial affordance graph (GSAG). 100 shared virtual spaces were generated from a combination of 10 host spaces and 10 client spaces, which were each created by the random arrangement of five single-cluster spaces based on real-space data. The results show that the object cluster registration (OCR) using the geometric spatial affordance graph (GSAG) may effectively form a shared virtual space in which object relationships are preserved. Additionally, when compared to the conventional methods that aim to maximize the area of the shared space, there was no significant decrease in the total area: Rather, a significant increase in the furniture area was found. This indicates that considering object relationships in the generation of shared virtual spaces to support a wider variety of interactions does not compromise the goal of maximizing the area and may even be beneficial towards this end.

The contributions of the present disclosure are as follows: First, the present disclosure proposes the geometric spatial affordance graph (GSAG), a novel approach that represents object relationships using facing formations based on geometric spatial affordances. Second, the present disclosure proposes the object cluster registration (OCR) using the geometric spatial affordance graph (GSAG) as a new approach to finding optimal object cluster pairs that minimize geometric dissimilarity while maximizing the weighted sum of edges in the matched clusters. The present disclosure may be a first attempt to view space as a set of relationships between objects based on geometric spatial affordance, rather than a set of individual objects that may be interacted with, to enable a wide variety of collaborative activities in a shared virtual space. The present disclosure may be beneficial for dynamic remote collaboration that leverages the user's own physical environment as a combination of multiple objects identified through their affordances and relationships. The present disclosure may present new directions for creating shared spaces between asymmetric spaces that enable higher levels of immersion and social presence among users in various mixed reality (MR) remote collaboration scenarios.

### BRIEF DESCRIPTION OF THE DRAWINGS

The above and other features and advantages of the present inventive concept will become more apparent by describing in detailed embodiments thereof with reference to the accompanying drawings, in which:

FIG. 1 is a diagram illustrating a shared virtual space of a host space and a client space according to a comparative embodiment;

FIG. 2 is a diagram illustrating a shared virtual space of a host space and a client space according to a present embodiment;

FIG. 3 is a diagram illustrating registered objects between the host space and the client space according to the comparative embodiment;

FIG. 4 is a diagram illustrating registered objects between the host space and the client space according to the present embodiment;

FIG. 5 is a diagram illustrating a method of an object cluster registration of dissimilar rooms according to the present embodiment using a geometric spatial affordance graph and a method of generating shared virtual space according to the present embodiment including the method of the object cluster registration of the dissimilar rooms;

FIG. 6 is a diagram illustrating a host object cluster in the host space and a client object cluster in the client space;

FIG. 7 is a diagram illustrating the host object cluster in the host space and the client object cluster in the client space which are represented in a form of the geometric spatial affordance graph;

FIG. 8 is a diagram illustrating a matched pair among the host object cluster of FIG. 7 and the client object cluster of FIG. 7;

FIG. 9 is a diagram illustrating the shared virtual space including the matched pair of FIG. 8;

FIG. 10 is a diagram illustrating a constraint surface, an action surface, a constraint vector, an action vector and a facing vector of a chair;

FIG. 11 is a diagram illustrating a constraint surface, an action surface, a constraint vector, an action vector and a facing vector of a sittable node when a node of the geometric spatial affordance graph is the sittable node;

FIG. 12 is a diagram illustrating an action surface, an action vector and a facing vector of a placeable node when a node of the geometric spatial affordance graph is the placeable node;

FIG. 13 is a diagram illustrating an action surface, an action vector and a facing vector of a displayable node when a node of the geometric spatial affordance graph is the displayable node;

FIG. 14 is a table illustrating edge generation conditions according to affordance combinations;

FIG. 15 is a diagram illustrating edge generation conditions between the sittable node and the sittable node;

FIG. 16 is a diagram illustrating edge generation conditions between the sittable node and the placeable node;

FIG. 17 is a diagram illustrating edge generation conditions between the sittable node and the displayable node;

FIG. 18 is a diagram illustrating edge generation conditions between the placeable node and the displayable node;

FIG. 19 is a diagram illustrating edge generation conditions between the placeable node and the placeable node;

FIG. 20 is a diagram illustrating edge generation conditions between the displayable node and the displayable node; and

FIG. 21 is a method of calculating a geometric dissimilarity between matched edges in a host geometric spatial affordance graph and a client geometric spatial affordance graph.

### DETAILED DESCRIPTION OF THE EMBODIMENTS

The present inventive concept now will be described more fully hereinafter with reference to the accompanying drawings, in which embodiments of the present invention are shown. The present inventive concept may, however, be embodied in many different forms and should not be construed as limited to the embodiments set forth herein.

Rather, these embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

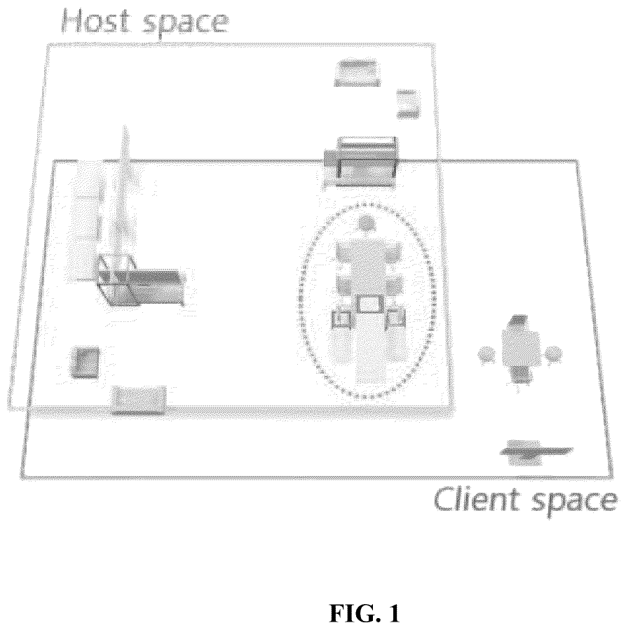

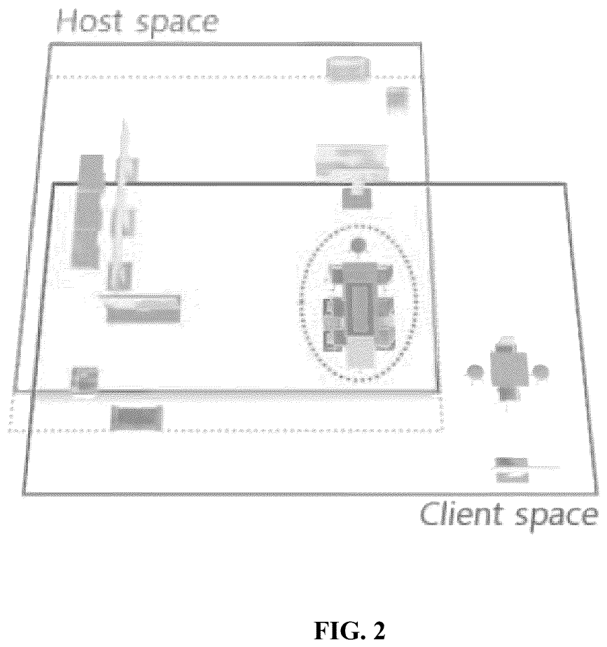

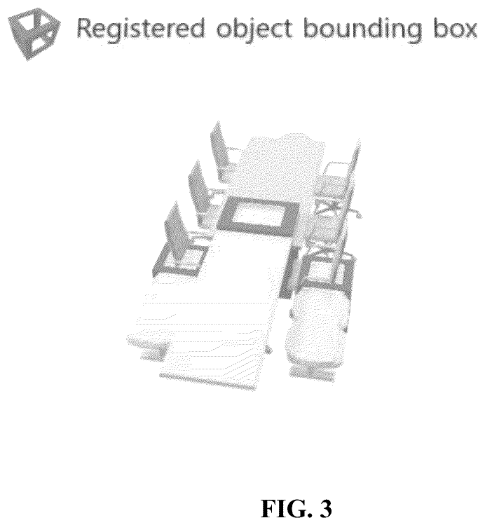

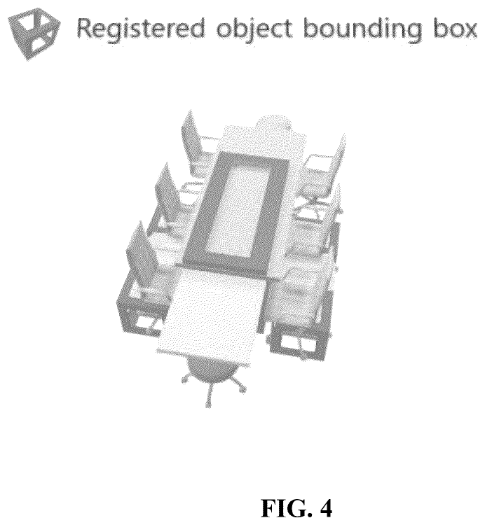

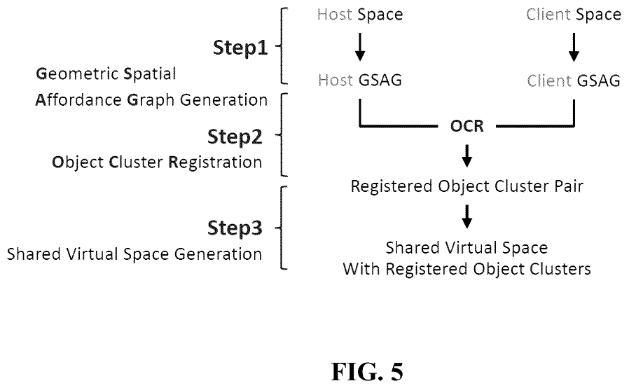

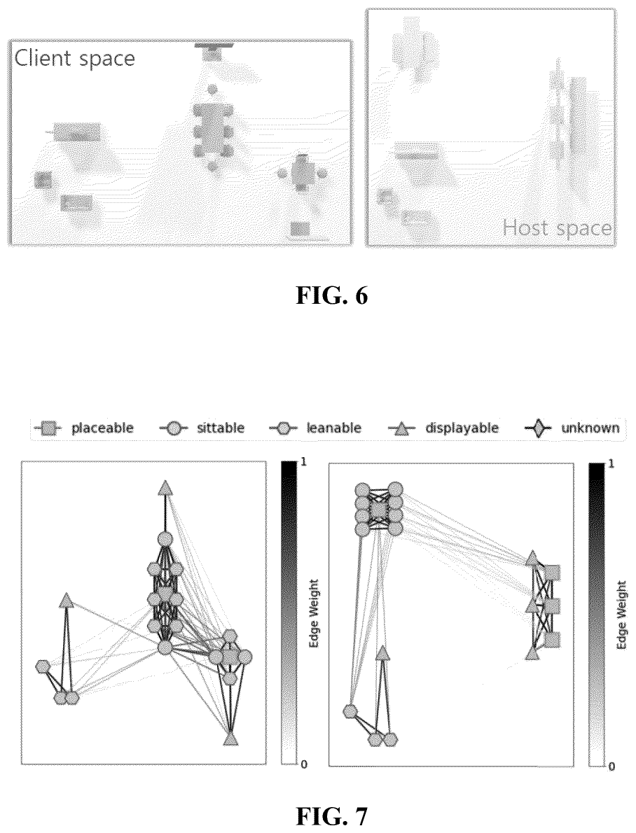

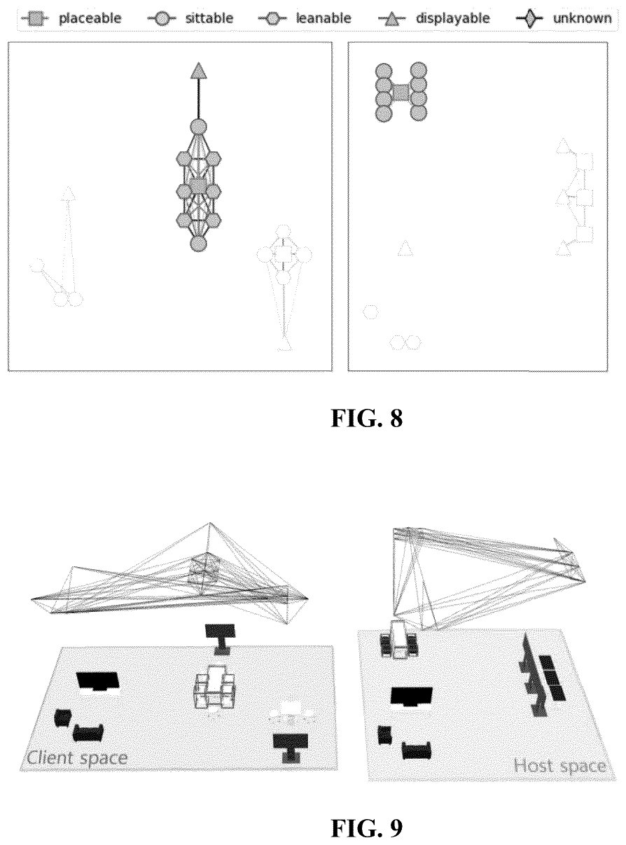

FIG. 1 is a diagram illustrating a shared virtual space of a host space and a client space according to a comparative embodiment. FIG. 2 is a diagram illustrating a shared virtual space of a host space and a client space according to a present embodiment. FIG. 3 is a diagram illustrating registered objects between the host space and the client space according to the comparative embodiment. FIG. 4 is a diagram illustrating registered objects between the host space and the client space according to the present embodiment. FIG. 5 is a diagram illustrating a method of an object cluster registration of dissimilar rooms according to the present embodiment using a geometric spatial affordance graph and a method of generating shared virtual space according to the present embodiment including the method of the object cluster registration of the dissimilar rooms. FIG. 6 is a diagram illustrating a host object cluster in the host space and a client object cluster in the client space. FIG. 7 is a diagram illustrating the host object cluster in the host space and the client object cluster in the client space which are represented in a form of the geometric spatial affordance graph. FIG. 8 is a diagram illustrating a matched pair among the host object cluster of FIG. 7 and the client object cluster of FIG. 7. FIG. 9 is a diagram illustrating the shared virtual space including the matched pair of FIG. 8.

Referring to FIGS. 1 to 9, the method of the object cluster registration of the dissimilar rooms according to the present inventive concept using the geometric spatial affordance graph includes generating a host geometric spatial affordance graph (Host GSAG) of the host space, generating a client geometric spatial affordance graph (Client GSAG) of the client space, generating a host object cluster by operating an object clustering for the host geometric spatial affordance graph (Host GSAG), generating a client object cluster by operating the object clustering for the client geometric spatial affordance graph (Client GSAG), and operating the object cluster registration (OCR) between the host object cluster and the client object cluster.

The method of generating the shared virtual space according to the present inventive concept includes generating the host geometric spatial affordance graph (Host GSAG) of the host space, generating the client geometric spatial affordance graph (Client GSAG) of the client space, generating the host object cluster by operating the object clustering for the host geometric spatial affordance graph (Host GSAG), generating the client object cluster by operating the object clustering for the client geometric spatial affordance graph (Client GSAG), operating the object cluster registration (OCR) between the host object cluster and the client object cluster and generating the shared virtual space based on the host object cluster and the client object cluster.

For example, the shared virtual space may be generated so that an overlapping space of the host space and the client space is maximized while maintaining a registration state of the host object cluster and the client object cluster.

FIG. 1 represents a result of generating the shared virtual space of the host space and the client space in a way which maximizes a size of a shared space without object cluster registration (OCR). FIG. 2 represents a result of generating the shared virtual space of the host space and the client space by the object cluster registration (OCR) using the geometric spatial affordance graph (GSAG).

FIG. 3 represents registered objects (green boxes) when generating the shared virtual space of the host space and the client space in the way which maximizes the size of the shared space without object cluster registration (OCR). FIG. 4 represents registered objects (green boxes) when generating the shared virtual space of the host space and the client space by the object cluster registration (OCR) using the geometric spatial affordance graph (GSAG). In the present inventive concept using the object cluster registration (OCR), more and wider co-interactable objects are registered as the same cluster.

Referring FIG. 5, the present inventive concept proposes the object cluster registration (OCR) to find co-interactable object cluster pairs with the geometric spatial affordance graph (GSAG) between asymmetric spaces for shared virtual space generation.

The object cluster registration (OCR) includes two steps: GSAG generation of a single room and OCR between asymmetric rooms.

In the GSAG generation step, node attributes are decided by both geometric and semantic information of objects and edges determined based on facing formation.

In the OCR step between asymmetric rooms, each GSAG is clustered and an optimal common cluster that maximizes the weighted sum of matched edges and minimizes geometric dissimilarity may be found. Through a collaboration space allocation, the registered cluster may be found among optimal common cluster pairs that may be interacted with. The generated shared virtual space, which reflects the common clusters, enables interactions based on multiple objects between dissimilar spaces.

FIG. 6 represents the host object cluster generated by operating the object clustering for the host space and the client object cluster generated by operating the object clustering for the client space.

FIG. 7 represents the host object cluster and the client object in the geometric spatial affordance graph (GSAG) form.

FIG. 8 represents the registered optimal object cluster pairs among the host object cluster and the client object.

FIG. 9 represents the registered objects in the shared virtual space.

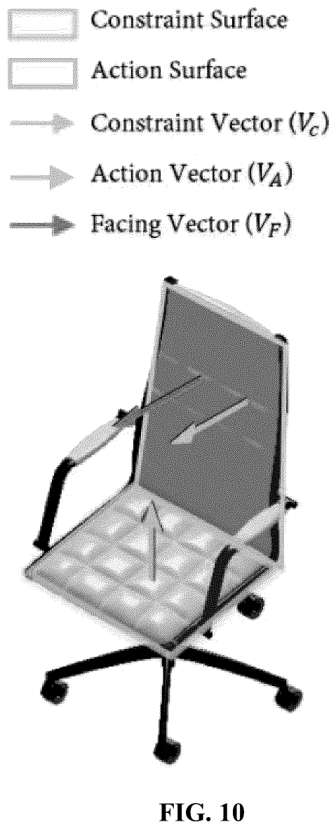

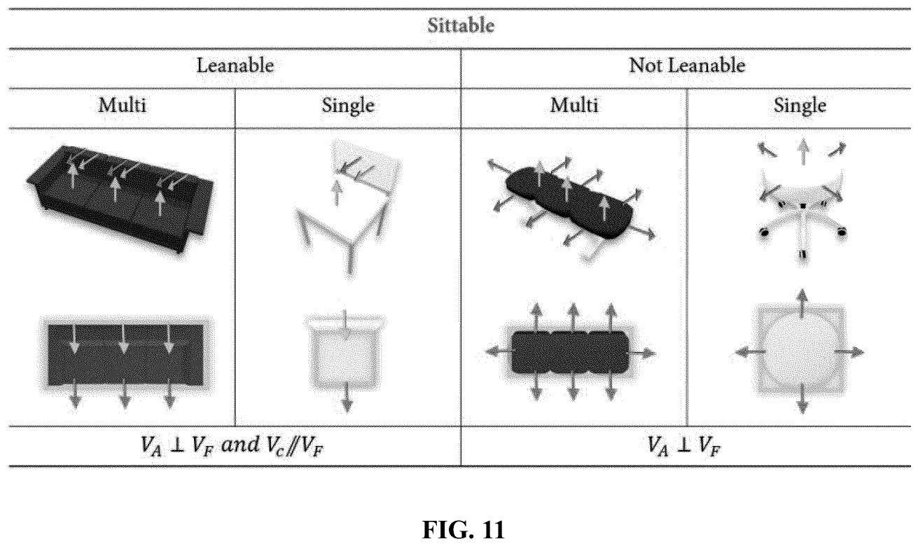

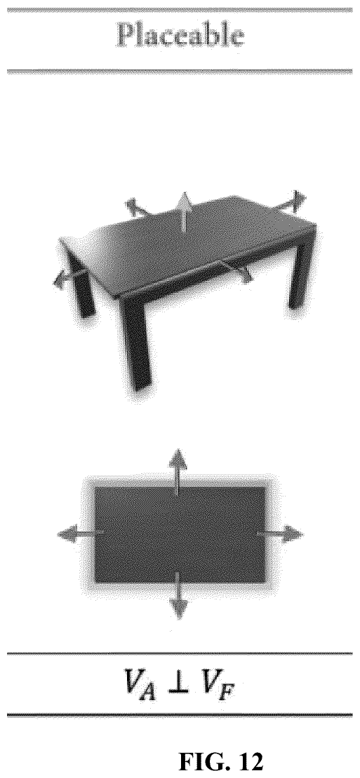

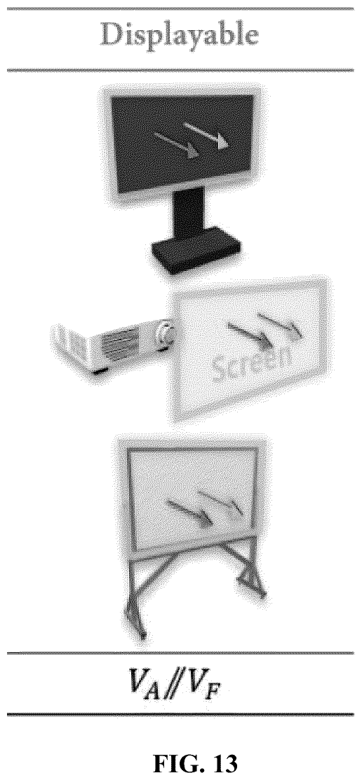

FIG. 10 is a diagram illustrating a constraint surface, an action surface, a constraint vector, an action vector and a facing vector of a chair. FIG. 11 is a diagram illustrating a constraint surface, an action surface, a constraint vector, an action vector and a facing vector of a sittable node when a node of the geometric spatial affordance graph is the sittable node. FIG. 12 is a diagram illustrating an action surface, an action vector and a facing vector of a placeable node when a node of the geometric spatial affordance graph is the placeable node. FIG. 13 is a diagram illustrating an action surface, an action vector and a facing vector of a displayable node when a node of the geometric spatial affordance graph is the displayable node.

Referring to FIGS. 1 to 13, the geometric spatial affordance graph (GSAG) includes nodes that correspond one-to-one with each object and edges, which are the relationships between them. GSAG uses a total of four affordances, a combination of three basic affordances (sittable, placeable, displayable) and leanable, which is dependent on sittable.

Each affordance represents the action possibilities of sitting, placing, displaying, and leaning. Three basic affordances were used to reflect user interactions with physical objects that are most likely to occur during remote collaboration, in terms of user position (sit) and action (place, display). Geometric spatial affordance based on the node's affordance and geometric information determines the facing vector that represents the interaction direction of the object. The facing vector represents the direction in which an object's action is possible. The plane where the action specified by affordance occurs is the action surface, and the vector perpendicular to the action surface is the action vector, which indicates the facing direction of the action. The plane that limits the direction of action is called the constraint surface, and the vector perpendicular to the constraint surface is the constraint vector. As shown in FIGS. 10 to 13, the action vector and the constraint vector are used to determine the facing vector considering affordances. The specific details of the facing vector in each affordance type are as follows.

### Sittable

Sitting action takes place on the horizontal plane of the seat. The facing vector of a sittable object is four direction vectors perpendicular to each side of the action vector and the edge of the action surface. Multi-person seats are divided into nodes for each single-person seat. For example, in the case of a 3-person seat, it is divided into three nodes, and the facing vector is formed for each, following the same method as in the case of a single-person seat.

### Leanable

When a sittable object is also leanable, users may only face a certain direction when they sit on the sittable object. The plane that generates this constraint is called a constraint surface, and the constraint vector is a vector perpendicular to the constraint surface. If a constraint vector exists, only the facing vector parallel to the constraint vector is valid. Multiperson seats that are leanable have two facing vectors per node, assuming that a virtual constraint vector occurs along the long side.

### Placeable

Placeable objects have a horizontal action surface, like a sittable. This applies to furniture that has a horizontal surface that allows the action of placing something, such as a desk or table. The placeable object has the facing vector perpendicular to the edge of the action surface and the action vector.

### Displayable

For displayable objects, the action surface may be vertical, not horizontal. When content is displayed on an action surface, users may view displayable objects in a direction perpendicular to the displayable objects. Therefore, both the action vector and the facing vector are perpendicular to the action surface and parallel to each other.

For example, at least one of the operation of generating the host geometric spatial affordance graph and the operation of generating the client geometric spatial affordance graph may include generating a plurality of nodes in the host geometric spatial affordance graph or in the client geometric spatial affordance graph and generating a plurality of edges connecting the nodes in the host geometric spatial affordance graph or in the client geometric spatial affordance graph.

For example, when the node may include a sittable node, the placeable node and the displayable node. The sittable node may refer to an object on which a user may sit. For example, the sittable node may include a chair and a sofa. The placeable node may refer to an object on which a user may place an item. For example, the placeable node may include a desk, a dining table and a table. The displayable node may refer to an object that displaying an image to a user. For example, the displayable node may include a television, a monitor and a screen.

The sittable node may include a leanable-sittable node and a not-leanable-sittable node. The leanable-sittable node may refer to a sittable node having a backrest. The not-leanable-sittable node may refer to a sittable node not having a backrest.

The leanable-sittable node may include the action surface, the constraint surface, the action vector perpendicular to the action surface, the constraint vector perpendicular to the constraint surface and the facing vector. When the action vector of the leanable-sittable node is V_{A}, the constraint vector of the leanable-sittable node is V_{C} and the facing vector of the leanable-sittable node is V_{F}, V_{A}⊥V_{F} and V_{C}//V_{F} may be satisfied.

The not-leanable-sittable node may include the action surface, the action vector perpendicular to the action surface and the facing vector. When the action vector of the not-leanable-sittable node is V_{A} and the facing vector of the not-leanable-sittable node is V_{F}, V_{A}⊥V_{F} may be satisfied.

The placeable node may include the action surface, the action vector perpendicular to the action surface and the facing vector. When the action vector of the placeable node is V_{A} and the facing vector of the placeable node is V_{F}, V_{A}⊥V_{F} may be satisfied.

The displayable node may include the action surface, the action vector perpendicular to the action surface and the facing vector. When the action vector of the displayable node is V_{A} and the facing vector of the displayable node is V_{F}, V_{A}//V_{F} may be satisfied.

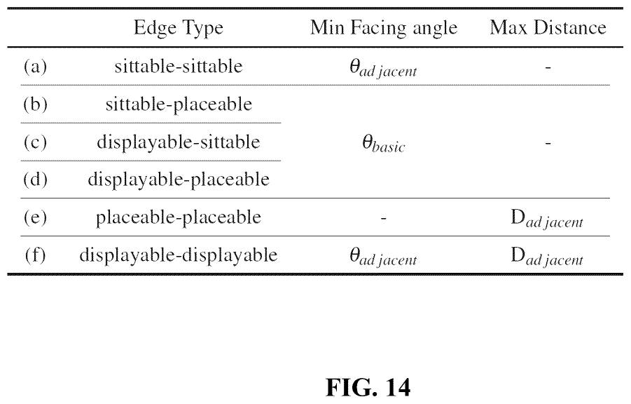

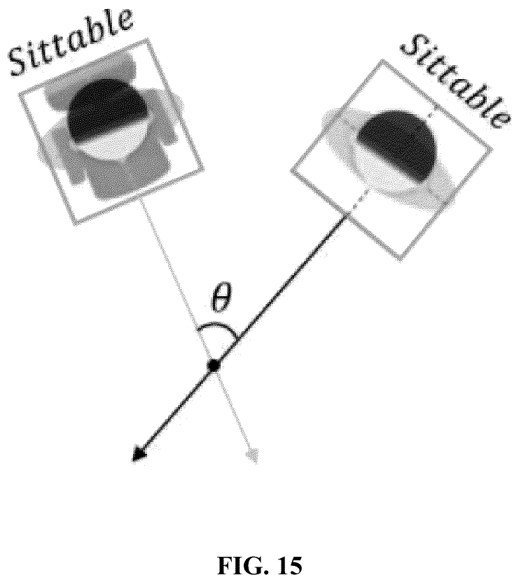

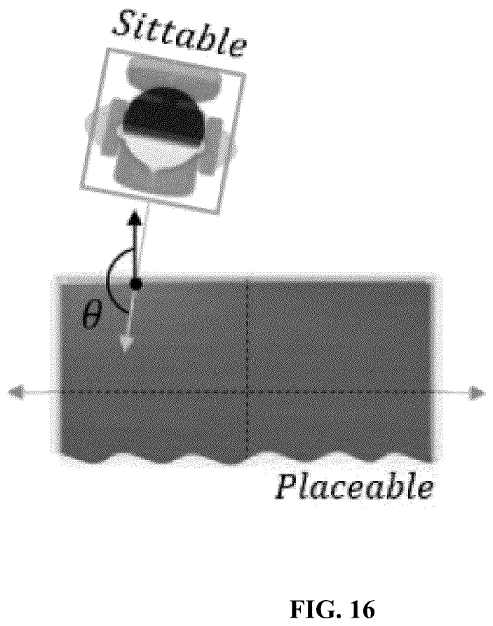

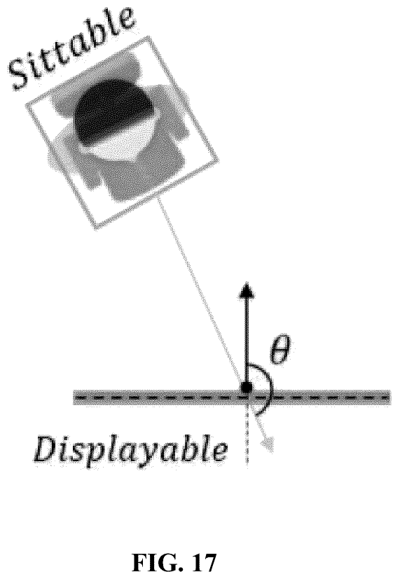

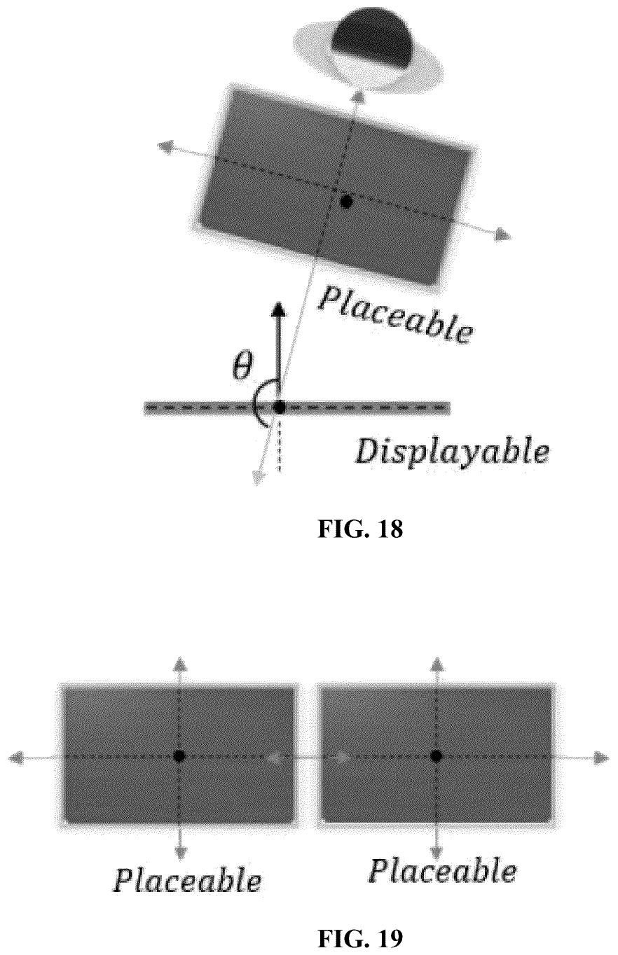

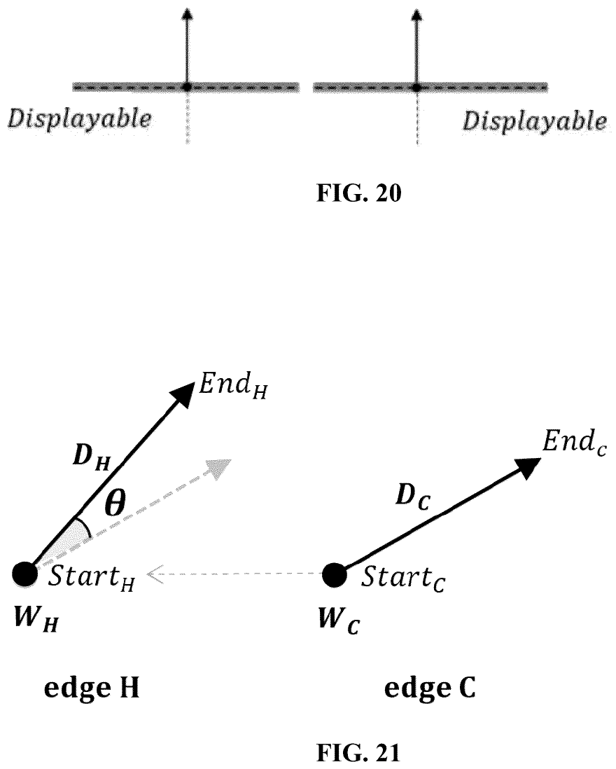

FIG. 14 is a table illustrating edge generation conditions according to affordance combinations. FIG. 15 is a diagram illustrating edge generation conditions between the sittable node and the sittable node. FIG. 16 is a diagram illustrating edge generation conditions between the sittable node and the placeable node. FIG. 17 is a diagram illustrating edge generation conditions between the sittable node and the displayable node. FIG. 18 is a diagram illustrating edge generation conditions between the placeable node and the displayable node. FIG. 19 is a diagram illustrating edge generation conditions between the placeable node and the placeable node. FIG. 20 is a diagram illustrating edge generation conditions between the displayable node and the displayable node. FIG. 21 is a method of calculating a geometric dissimilarity between matched edges in a host geometric spatial affordance graph and a client geometric spatial affordance graph.

Referring to FIGS. 1 to 21, the edge of GSAG expresses the relationship between two objects, and the edge of GSAG may be generated based on the facing formation that reflects the locational characteristics for people to interact with each other.

In GSAG, an edge may be generated if there is a formation that allows furniture to interact with each other based on their location and direction, which represents the possibility of multi-object interaction.

Among the facing vectors of the edge's start and end nodes, the facing vector perpendicular to the edge of the closest action surface is used to generate the edge.

As shown in FIGS. 14 to 20, the edge is generated when the opposing vectors of each node point toward each other, and the facing criterion varies depending on the edge type. The minimum angle for facing is θ_{basic} and is set to 135° considering face-to-face formation. Edges between sittable nodes apply θ_{adjacent} (e.g. 45°) to allow both L-shaped formation and face-to-face formation. For the placeable objects to be connected and used together as a multi-object interaction, they must meet the maximum distance D_{adjacent} (e.g. 0.1 m). Edges between displayable nodes have connectivity by satisfying both of the previous two conditions.

For example, when the edge type is one of sittable-sittable and displayable-displayable and an angle between a first facing vector of a first node and a second facing vector of a second node is less than θ_{adjacent}, the edge may not be generated between the first node and the second node.

For example, when the edge type is one of sittable-placeable, displayable-sittable and displayable-placeable and an angle between a first facing vector of a first node and a second facing vector of a second node is less than θ_{basic}, the edge may not be generated between the first node and the second node.

For example, when the edge type is one of placeable-placeable and displayable-displayable and a distance between a first node and a second node is greater than D_{adjacent}, the edge may not be generated between the first node and the second node.

For example, θ_{basic} may be 135°, θ_{adjacent} may be 45° and D_{adjacent} may be 0.1 m.

An edge weight of the edge may have a value between zero and one. As the interaction between the nodes connected to the edge increases, the edge weight may increase.

When the edge weight is w_{edge}, i is a start node, j is an end node, Â(i,j) is a facing vector angle between a facing vector of the start node and a facing vector of the end node, \hat{D}(i,j) is a Manhattan distance between the start node and the end node, ω_{A} is an angle coefficient and ω_{D} is a distance coefficient, w_{edge}(i,j)=ω_{A}Â(i,j)+ω_{D}\hat{D}(i,j) may be satisfied.

When G is the geometric spatial affordance graph, n(G) is a number of nodes in the geometric spatial affordance graph and W(G) is a graph weight of the geometric spatial affordance graph,

$$W ( G ) = {\sum }_{i , j = 1}^{n ( G )} {w}_{edge} ( i , j )$$

may be satisfied.

Â(i,j) is the facing vector angle between the facing vector of the start node i and the facing vector of the end node j and may be normalized by dividing by a maximum value of 180. \hat{D}(i,j) is the Manhattan distance between the start node i and the end node j and may be normalized using maximum and minimum distance values among all edges in the graph G. Through this, an importance may be determined based on a relative difference between distances. The coefficient ω_{A} and ω_{D} may be weights in each term. The relative distance may consider a detour of user movement using the Manhattan distance between two objects. When the displayable node is at the start or end node, an offset (1 m) may be corrected to take long-distance interactivity into account.

The weight W(G) for a graph G may be the sum of the edge weight wedge of each edge, calculated from the facing vector angle and Manhattan distance.

After generating the GSAG for each space, the optimal cluster pair may be found in the asymmetric space through OCR.

The cluster found the optimal partition that promoted modularity optimization through the Louvain Community Detection Algorithm.

Two main goals decide the optimal cluster pair between GSAG. The first goal is to secure as many common relationships as possible. This leads to the possibility of various interactions in the shared virtual spaces. However, since more relationships are matched, more geometric dissimilarity between objects within the secured area inevitably occurs. Therefore, the second goal is to minimize the resulting geometric dissimilarity while accomplishing the first goal. The process of finding the optimal solution between two conflicting goals is the core of OCR and is expressed as an objective function O(G_{H},G_{C}) below.

When G_{H} is the host geometric spatial affordance graph, G_{C} is the client geometric spatial affordance graph, O(G_{H},G_{C}) is the objective function of the object cluster registration, ψᵣₑₗₐₜᵢₒₙ(G_{H},G_{C}) is a relational similarity, ψ_{geometric}(G_{H},G_{C}) is a geometric dissimilarity, ωᵣ is a relational similarity coefficient and ω_{g} is a geometric dissimilarity coefficient, O(G_{H},G_{C})=ωᵣψᵣₑₗₐₜᵢₒₙ(G_{G},G_{C})−ω_{g}ψ_{geometric}(G_{H},G_{C}) may be satisfied.

Given the host geometric spatial affordance graph G_{H} and the client geometric spatial affordance graph G_{C}, ψ_{geometric}(G_{H},G_{C}) is a term of how many relationships are matched in the two given graphs. At the same time, geometric dissimilarity calculated as the difference in direction and distance between matched edges must be minimized. Details of each term are as follows. Both ωᵣ and ω_{g} may be positive real numbers less than one.

ψᵣₑₗₐₜᵢₒₙ(G_{H},G_{C}) may mean how much the sum of matched edges accounts for the sum of the weight of the entire graphs based on Jaccard similarity.

When g_{H} is a matched cluster in the host geometric spatial affordance graph and g_{C} is a matched cluster in the client geometric spatial affordance graph,

$${ψ}_{relation} ( {G}_{H} , {G}_{C} ) = \frac{W ( {g}_{H} ) + W ( {g}_{C} )}{W ( {G}_{H} ) + W ( {G}_{C} )}$$

may be satisfied.

In

$${ψ}_{relation} ( {G}_{H} , {G}_{C} ) = \frac{W ( {g}_{H} ) + W ( {g}_{C} )}{W ( {G}_{H} ) + W ( {G}_{C} )} ,$$

the weighted sum of matched clusters, g_{H} and g_{C} may be divided by the total weight sum of given graphs, G_{H} and G_{C}. For g_{H} and g_{C}, all subgraphs of G_{H} and G_{C} are candidates.

Geometric dissimilarity ψ_{geometric}(G_{H},G_{C}) may include an angle dissimilarity and a distance dissimilarity.

When iₕ is a start node in the host geometric spatial affordance graph, jₕ is an end node in the host geometric spatial affordance graph, i_{c} is a start node in the client geometric spatial affordance graph, j_{c} is an end node in the client geometric spatial affordance graph and N is a number of nodes in the matched cluster in the host geometric spatial affordance graph,

$${ψ}_{geometric} ( {G}_{H} , {G}_{C} ) = {\sum }_{{i}_{h} , {j}_{h} , {i}_{c} , {j}_{c} = 1}^{N} ( {w}_{edge} ( {i}_{h} , {j}_{h} ) - {w}_{edge} ( {i}_{c} , {j}_{c} ) )$$

may be satisfied.

Â(i,j) is the sum of values normalized by dividing the angle difference between matched edge pairs, (i,j), in the matched cluster by 180 degrees. As shown in FIG. 21, the angle θ between edges (edge H and edge C) within each graph may be calculated as an angle difference between vectors from the start nodes (Start_{H} and Start_{C}) to the end node (End_{H} and End_{C}) of each edge. Herein, W_{H} and W_{C} may mean the edge weights of the edges (edge H and edge C).

N is the number of nodes in g_{H} and the number of nodes in g_{H} is also same as the number of nodes in g_{C}. Normalized distance dissimilarity \hat{D}(i,j) may be calculated based on a distance (D_{H} and D_{C}) difference between matched edge pairs within the matched cluster. The theoretical minimum value of \hat{D}(i,j) is 0 and the maximum value is infinite. Considering this, by using a Sigmoid function, the closer \hat{D}(i,j) is to 0, the lower the positional dissimilarity between the two edges is, so the value gets closer to 1. Conversely, as the term value becomes larger, it means that they have high positional dissimilarity, so it approaches 0.

Based on optimal cluster pairs, a shared virtual space that secures relationships between objects may be formed. The existing shared space formation method adds all object areas with the same affordance when overlayed and measures the area with the largest final area. In this case, all objects in the space have equal importance. The core of the proposed shared space generation through OCR may aim to target registered optimal cluster pairs and maximize the overlapping area of the corresponding objects. When maximizing the area, the space may be searched in all four directions. In addition, in the proposed method, a condition was added that the allocated object area must be at least 0.1 m² or at least 10% of the original area of the overlapping object for interactions to be possible.

The host object cluster and the client object cluster may be registered such that their relational similarity increases and their geometric dissimilarity decreases.

For example, the relational similarity may be determined by a ratio of a total sum of edge weights in the host object cluster matched with the client object cluster and a total sum of edge weights in the client object cluster matched with the host object cluster to a total sum of edge weights in the host geometric spatial affordance graph and a total sum of edge weights in the client geometric spatial affordance graph.

For example, the geometric dissimilarity may be determined based on a cumulative difference between individual edge weights in the host geometric spatial affordance graph and individual edge weights in the client geometric spatial affordance graph.

An electronic system according to the present embodiment generates the host geometric spatial affordance graph (Host GSAG) of the host space, generates the client geometric spatial affordance graph (Client GSAG) of the client space, generates the host object cluster by operating the object clustering for the host geometric spatial affordance graph (Host GSAG), generates the client object cluster by operating the object clustering for the client geometric spatial affordance graph (Client GSAG).

The electronic system may include an augmented reality (AR) device worn by a first user disposed in the host space and a virtual reality (VR) device worn by a second user located in the client space. The AR device may display a shared virtual space generated based on the matched host object cluster and the client object cluster. The VR device may display the shared virtual space generated based on the matched host object cluster and the client object cluster.

The host space and the client space may be registered based on furniture in the host space so that the first user disposed in the host space may wear the AR device and the second user disposed in the client space may wear the VR device. However, the present inventive concept may not be limited thereto. Alternatively, both the first user disposed in the host space and the second user disposed in the client space may wear the VR device.

For example, a program for executing the method of the object cluster registration of dissimilar rooms according to the present embodiment on a computer may be recorded on a computer-readable storage medium. For example, a program for executing the method of generating shared virtual spaces according to the present embodiment on a computer may be recorded on a computer-readable storage medium.

For example, the method of the object cluster registration of dissimilar rooms according to the present embodiment may be operated by a computing device. For example, the method of generating shared virtual spaces according to the present embodiment may be operated by a computing device.

According to the present embodiment, a new data structure called a geometric spatial affordance graph (GSAG) based on the facing formation between objects is proposed. The geometric spatial affordance graph (GSAG) may reflect both geometric attributes and semantic attributes. An object cluster registration (OCR) method using the geometric spatial affordance graph (GSAG) is proposed. In the object cluster registration (OCR) method, interactable object clusters may be identified and registered based on affordances. By connecting object clusters through the object cluster registration (OCR), the generated shared virtual space may allow for a wider range of interactions. A technical advantage of the geometric spatial affordance graph (GSAG) is that it does not view objects as individual entities by considering the facing direction and distance of the furniture and determining relationships through these. A technical advantage of the object cluster registration (OCR) lies in the ability to ensure a wider range and greater number of shared objects that may be used together in a shared virtual space.

A capacity of the object cluster registration (OCR) may be demonstrated by comparing registered edge-IoU (REI) and registered area-IoU (RAI) of the shared virtual spaces generated by the object cluster registration (OCR) with conventional methods that do not apply the object cluster registration (OCR) using the geometric spatial affordance graph (GSAG). 100 shared virtual spaces were generated from a combination of 10 host spaces and 10 client spaces, which were each created by the random arrangement of five single-cluster spaces based on real-space data. The results show that the object cluster registration (OCR) using the geometric spatial affordance graph (GSAG) may effectively form a shared virtual space in which object relationships are preserved. Additionally, when compared to the conventional methods that aim to maximize the area of the shared space, there was no significant decrease in the total area: Rather, a significant increase in the furniture area was found. This indicates that considering object relationships in the generation of shared virtual spaces to support a wider variety of interactions does not compromise the goal of maximizing the area and may even be beneficial towards this end.

The contributions of the present disclosure are as follows: First, the present disclosure proposes the geometric spatial affordance graph (GSAG), a novel approach that represents object relationships using facing formations based on geometric spatial affordances. Second, the present disclosure proposes the object cluster registration (OCR) using the geometric spatial affordance graph (GSAG) as a new approach to finding optimal object cluster pairs that minimize geometric dissimilarity while maximizing the weighted sum of edges in the matched clusters. The present disclosure may be a first attempt to view space as a set of relationships between objects based on geometric spatial affordance, rather than a set of individual objects that may be interacted with, to enable a wide variety of collaborative activities in a shared virtual space. The present disclosure may be beneficial for dynamic remote collaboration that leverages the user's own physical environment as a combination of multiple objects identified through their affordances and relationships. The present disclosure may present new directions for creating shared spaces between asymmetric spaces that enable higher levels of immersion and social presence among users in various mixed reality (MR) remote collaboration scenarios.

According to the present inventive concept, the object clusters may be connected by the object cluster registration so that the generated shared virtual space may enable more extensive interactions.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A method of an object cluster registration of dissimilar rooms using a geometric spatial affordance graph, the method comprising:
generating a host geometric spatial affordance graph of a host space;
generating a client geometric spatial affordance graph of a client space;
generating a host object cluster by operating an object clustering for the host geometric spatial affordance graph;
generating a client object cluster by operating the object clustering for the client geometric spatial affordance graph; and
operating the object cluster registration between the host object cluster and the client object cluster.

2. The method of claim 1, wherein at least one of the generating the host geometric spatial affordance graph and the generating the client geometric spatial affordance graph includes:
generating a plurality of nodes in the host geometric spatial affordance graph or in the client geometric spatial affordance graph; and
generating a plurality of edges connecting the nodes in the host geometric spatial affordance graph or in the client geometric spatial affordance graph.

3. The method of claim 2, wherein the node includes a sittable node, a placeable node and a displayable node.

4. The method of claim 3, wherein the sittable node includes a leanable-sittable node and a not-leanable-sittable node.

5. The method of claim 4, wherein the leanable-sittable node includes an action surface, a constraint surface, an action vector perpendicular to the action surface, a constraint vector perpendicular to the constraint surface and a facing vector.

6. The method of claim 5, wherein when the action vector of the leanable-sittable node is V_{A}, the constraint vector of the leanable-sittable node is V_{C} and the facing vector of the leanable-sittable node is V_{F}, V_{A}⊥V_{F} and V_{C}//V_{F} is satisfied.

7. The method of claim 4, wherein the not-leanable-sittable node includes an action surface, an action vector perpendicular to the action surface and a facing vector.

8. The method of claim 7, wherein when the action vector of the not-leanable-sittable node is V_{A} and the facing vector of the not-leanable-sittable node is V_{F}, V_{A}⊥V_{F} is satisfied.

9. The method of claim 3, wherein the placeable node includes an action surface, an action vector perpendicular to the action surface and a facing vector.

10. The method of claim 9, wherein when the action vector of the placeable node is V_{A} and the facing vector of the placeable node is V_{F}, V_{A}⊥V_{F} is satisfied.

11. The method of claim 3, wherein the displayable node includes an action surface, an action vector perpendicular to the action surface and a facing vector.

12. The method of claim 11, wherein the action vector of the displayable node is V_{A} and the facing vector of the displayable node is V_{F}, V_{A}//V_{F} is satisfied.

13. The method of claim 3, wherein when an edge type is one of sittable-sittable and displayable-displayable and an angle between a first facing vector of a first node and a second facing vector of a second node is less than θ_{adjacent}, the edge is not generated between the first node and the second node.

14. The method of claim 3, wherein when an edge type is one of sittable-placeable, displayable-sittable and displayable-placeable and an angle between a first facing vector of a first node and a second facing vector of a second node is less than θ_{basic}, the edge is not generated between the first node and the second node.

15. The method of claim 3, wherein when an edge type is one of placeable-placeable and displayable-displayable and a distance between a first node and a second node is greater than D_{adjacent}, the edge is not generated between the first node and the second node.

16. The method of claim 2, wherein an edge weight of the edge has a value between zero and one,
wherein as an interaction between nodes connected to the edge increases, the edge weight increases.

17. The method of claim 16, wherein when the edge weight is w_{edge}, i is a start node, j is an end node, Â(i,j) is a facing vector angle between a facing vector of the start node and a facing vector of the end node, \hat{D}(i,j) is a Manhattan distance between the start node and the end node, ω_{A} is an angle coefficient and ω_{D} is a distance coefficient, w_{edge}(i,j)=ω_{A}Â(i,j)+ω_{D}\hat{D}(i,j) is satisfied.

18. The method of claim 2, wherein the host object cluster and the client object cluster are registered such that a relational similarity between the host object cluster and the client object cluster increases and a geometric dissimilarity between the host object cluster and the client object cluster decreases.

19. The method of claim 18, wherein the relational similarity is determined by a ratio of a total sum of edge weights in the host object cluster matched with the client object cluster and a total sum of edge weights in the client object cluster matched with the host object cluster to a total sum of edge weights in the host geometric spatial affordance graph and a total sum of edge weights in the client geometric spatial affordance graph.

20. The method of claim 18, wherein the geometric dissimilarity is determined based on a cumulative difference between individual edge weights in the host geometric spatial affordance graph and individual edge weights in the client geometric spatial affordance graph.

21. The method of claim 18, wherein when G_{H} is the host geometric spatial affordance graph, G_{C} is the client geometric spatial affordance graph, O(G_{H},G_{C}) is an objective function of the object cluster registration, ψᵣₑₗₐₜᵢₒₙ(G_{H},G_{C}) is the relational similarity, ω_{g} is the geometric dissimilarity, r is a relational similarity coefficient and is a geometric dissimilarity coefficient, O(G_{H},G_{C})==ωᵣψᵣₑₗₐₜᵢₒₙ(G_{H},G_{C})−ω_{g}ψᵣₑₗₐₜᵢₒₙ(G_{H},G_{C}) is satisfied.

22. The method of claim 21, wherein when an edge weight of the edge is w_{edge}, i is a start node, j is an end node, Â(i,j) is a facing vector angle between a facing vector of the start node and a facing vector of the end node, is a Manhattan distance between the start node and the end node, ω_{A} is an angle coefficient and ω_{D} is a distance coefficient, w_{edge}(i,j)=ω_{A}Â(i,j)+ω_{D}\hat{D}(i,j) is satisfied,
wherein when G is the geometric spatial affordance graph, n(G) is a number of the nodes in the geometric spatial affordance graph and W(G) is a graph weight of the geometric spatial affordance graph,
$$W ( G ) = {\sum }_{i , j = 1}^{n ( G )} {w}_{edge} ( i , j )$$
is satisfied, and
wherein when g_{H} is a matched cluster in the host geometric spatial affordance graph and g_{C} is a matched cluster in the client geometric spatial affordance graph,
$${ψ}_{relation} ( {G}_{H} , {G}_{C} ) = \frac{W ( {g}_{H} ) + W ( {g}_{C} )}{W ( {G}_{H} ) + W ( {G}_{C} )}$$
is satisfied.

23. The method of claim 21, wherein when an edge weight of the edge is w_{edge}, i is a start node, j is an end node, Â(i,j) is a facing vector angle between a facing vector of the start node and a facing vector of the end node, \hat{D}(i,j) is a Manhattan distance between the start node and the end node, ω_{A} is an angle coefficient and ω_{D} is a distance coefficient, w_{edge}(i,j)=ω_{A}Â(i,j)+ω_{D}\hat{D}(i,j) is satisfied, and
wherein when iₕ is a start node in the host geometric spatial affordance graph, jₕ is an end node in the host geometric spatial affordance graph, i_{c} is a start node in the client geometric spatial affordance graph, j_{c} is an end node in the client geometric spatial affordance graph and N is a number of nodes in the matched cluster in the host geometric spatial affordance graph,
$${ψ}_{geometric} ( {G}_{H} , {G}_{C} ) = {\sum }_{{i}_{h} , {j}_{h} , {i}_{c} , {j}_{c} = 1}^{N} ( {w}_{edge} ( {i}_{h} , {j}_{h} ) - {w}_{edge} ( {i}_{c} , {j}_{c} ) )$$
is satisfied.

24. A method of generating shared virtual space, the method comprising:
generating a host geometric spatial affordance graph of a host space;
generating a client geometric spatial affordance graph of a client space;
generating a host object cluster by operating an object clustering for the host geometric spatial affordance graph;
generating a client object cluster by operating the object clustering for the client geometric spatial affordance graph;
operating an object cluster registration between the host object cluster and the client object cluster; and
generating the shared virtual space based on the host object cluster and the client object cluster.

25. The method of claim 24, wherein the shared virtual space is generated so that an overlapping space of the host space and the client space is maximized while maintaining a registration state of the host object cluster and the client object cluster.

26. The method of claim 24, wherein at least one of the generating the host geometric spatial affordance graph and the generating the client geometric spatial affordance graph includes:
generating a plurality of nodes in the host geometric spatial affordance graph or in the client geometric spatial affordance graph; and
generating a plurality of edges connecting the nodes in the host geometric spatial affordance graph or in the client geometric spatial affordance graph.

27. The method of claim 26, wherein the host object cluster and the client object cluster are registered such that a relational similarity between the host object cluster and the client object cluster increases and a geometric dissimilarity between the host object cluster and the client object cluster decreases.

28. An electronic system, the electronic system configured to generate a host geometric spatial affordance graph of a host space, generate a client geometric spatial affordance graph of a client space, generate a host object cluster by operating an object clustering for the host geometric spatial affordance graph and generate a client object cluster by operating the object clustering for the client geometric spatial affordance graph.

29. The electronic system of claim 28, wherein the electronic system comprises:
an augmented reality (AR) device worn by a first user disposed in the host space; and
a virtual reality (VR) device worn by a second user located in the client space,
wherein the AR device is configured to display a shared virtual space generated based on the matched host object cluster and the client object cluster, and
wherein the VR device is configured to display the shared virtual space generated based on the matched host object cluster and the client object cluster.

30. A non-transitory computer-readable storage medium having stored thereon program instructions, the program instructions executable by at least one hardware processor to:
generate a host geometric spatial affordance graph of a host space;
generate a client geometric spatial affordance graph of a client space;
generate a host object cluster by operating an object clustering for the host geometric spatial affordance graph;
generate a client object cluster by operating the object clustering for the client geometric spatial affordance graph; and
operate an object cluster registration between the host object cluster and the client object cluster.
